(19) United States
(12) Patent Application Publication
(10) Pub. No.: US 2005/0219133 A1
(43) Pub. Date: Oct. 6, 2005

(54) Phase shifting network

(76) Inventor: Robert Douglas Elliot, Naperville, IL (US)

Correspondence Address: WELSH & KATZ, LTD, 120 S RIVERSIDE PLAZA, 22ND FLOOR, CHICAGO, IL, 60606, US

(21) Appl. No.: 10/818,615

(22) Filed: Apr. 6, 2004

(51) Int. Cl. H01Q 3/00

(52) U.S. Cl. 343/757; 343/853

(57) ABSTRACT

A phase shifting network including a main power divider having a main input, first and second main outputs, and means for dividing power received at the main input between the first and second main outputs. A first differential phase shifter is provided. The first differential phase shifter has a first input, first and second outputs, and a first phase shift adjuster which can be moved to adjust the phase difference between the first and second outputs. The first input is connected to the first main output and the first differential phase shifter is configured to divide power from the first input between the first and second outputs. A second differential phase shifter is also provided. The second differential phase shifter has a second input, third and fourth outputs, and a second phase shift adjuster which can be moved to adjust the phase difference between the third and fourth outputs. The second input is connected to the second main output and the second differential phase shifter is configured to divide power from the second input between the third and fourth outputs. A control system is configured to drive the first phase shift adjuster and the second phase shift adjuster, such that the degree of adjustment of one of the phase shift adjusters is dependent upon the degree of adjustment of the other phase shift adjuster. The phase difference between the first and second outputs, the second and third outputs, and the first and fourth outputs is substantially equal.

### FIELD OF THE INVENTION

The invention relates to a phase shifting network. In particular, the invention relates to a phase shifting network for feeding, and adjusting the phase between, two or more pairs of antenna elements.

### BACKGROUND OF THE INVENTION

Phase shifting networks are used to adjust the radiation patterns of antennas. By adjusting the phase angle of individual antenna elements, it is possible to adjust properties of the antenna beam, such as down tilt and beam width. These adjustments are desirable as they make it possible to adjust the area covered by the antenna or to improve antenna performance.

U.S. Pat. No. 6,198,458 describes a network which employs differential phase shifters, as shown schematically in FIG. 1. The antenna consists of four antenna elements 5, 6, 7, 8. The antenna elements are fed by an input 12 via a phase shifting network 13. The phase shifting network 13 consists of a first differential phase shifter 14 which receives the input signal from the input 12 and divides it into intermediate signals for transmission over lines 15 and 16. The differential phase shifter 14 also adjusts the relative phase of the intermediate signals.

Similarly, the second differential phase shifters 17, 18 receive the intermediate signals and divide them into signals for transmission to the antenna elements 5, 6, 7, 8 over lines 19, 20, 21, 22. The second differential phase shifters 17,18 also adjust the relative phase of signals transmitted to the antennas 5, 6 and 7, 8.

WO03/034547 discloses an antenna array with differential phase shifters. This system is shown schematically in FIG. 2. The antenna comprises four antenna elements arranged as an inner pair 25 and an outer pair 26. The antenna is fed by input 27 via a phase shifting network 28. The phase shifting network 28 comprises a feed arm 29 which is connected to and pivots about the input 27. The feed arm 29 couples to the semi-circular transmission lines 30 and 31 such that by rotating the arm the relative phase between elements of each pair can be adjusted.

The antenna elements shown in FIGS. 1 and 2 are arranged in a line in a length direction “L”, thus lending themselves to a long and thin antenna shape. A disadvantage of the prior art shifting networks is that they are unsuitable for such an antenna shape because they are bulky in the width direction “W”, perpendicular to “L”.

The antenna of U.S. Pat. No. 6,198,458 requires three differential phase shifters. It is desirable to minimise the number of phase shifters required, thereby reducing bulk and complexity.

The antenna of WO 03/034547, while using only two differential phase shifters, is necessarily bulky in the “W” direction due to the length of the feed arm 29. This problem would worsen if the number of antenna elements was increased. In the two pair configuration shown in FIG. 2, the inner semi-circular transmission line 31 has a radius, r. To maintain an equal phase difference between adjacent antenna elements, the radius of the outer semi-circular transmission line 30 must be 3r. If fifth and sixth elements were added then the radius of the third semi-circular transmission line would need to be 5r, and so on.

Power division is also somewhat complex in the antenna of WO 03/034547. In particular, the feed arm 29 must be precisely shaped with wide transformer portions in order to divide power equally between the inner and outer pairs of antenna elements.

### SUMMARY OF EXEMPLARY EMBODIMENTS

It is an object of the invention to provide an antenna phase shifting network for adjusting phase between antenna elements arranged as an inner pair and an outer pair, with lower bulk than prior systems. It is a further object of the invention to provide an antenna phase shifting network with phase shift adjusters of a relatively simple construction.

A first exemplary embodiment provides a phase shifting network including:
a main power divider having a main input, first and second main outputs, and means for dividing power received at the main input between the first and second main outputs;
a first differential phase shifter comprising a first input, first and second outputs, and a first phase shift adjuster which can be moved to adjust the phase difference between the first and second outputs, wherein the first input is connected to the first main output and the first differential phase shifter is configured to divide power from the first input between the first and second outputs;
a second differential phase shifter comprising a second input, third and fourth outputs, and a second phase shift adjuster which can be moved to adjust the phase difference between the third and fourth outputs, wherein the second input is connected to the second main output and the second differential phase shifter is configured to divide power from the second input between the third and fourth outputs;
and a control system configured to drive the first phase shift adjuster and the second phase shift adjuster at a ratio of approximately 1:3.

This arrangement provides a reduced number of differential phase shifters, compared with the arrangement of FIG. 1. It also provides an alternative power division arrangement compared with FIG. 2.

The 1:3 ratio ensures that the phase difference between the first and second outputs, the second and third outputs, and the first and fourth outputs is approximately equal. When employed in an antenna, this enables adjacent radiating elements to be equally spaced. The ratio may vary by up to 10% or more from the preferred ratio of 1:3, but preferably the ratio is 1:3+/−5%.

In one exemplary embodiment there is provided a combined phase shifting network comprising a principal differential phase shifter having a principal input, a plurality of principal outputs, and a principal phase shift adjuster which can be moved to adjust the phase differences between the principal outputs, wherein the principal differential phase shifter is configured to divide power from the principal input between the principal outputs; and a plurality of phase shifting networks as described above; wherein each of the plurality of principal outputs is connected to the main input of one of the plurality of phase shifting networks.

The network may have an odd number of outputs, but most preferably has only an even number of outputs. An even number of outputs is advantageous for use in an antenna with an even number of radiating elements.

The network is preferably employed in an antenna comprising four antenna elements arranged substantially linearly in an inner pair and an outer pair. Typically the antenna elements are spaced apart along a length of the antenna, and the differential phase shifters are spaced apart along the length of the antenna, typically in a linear fashion.

A second exemplary embodiment of the invention provides a phase shifting network including:
a main power divider having a main input, first and second main outputs, and means for dividing power received at the main input between the first and second main outputs;
a first differential phase shifter comprising a first input, first and second network outputs, and a first phase shift adjuster which can be moved to adjust the phase difference between the first and second network outputs, wherein the first input is connected to the first main output and the first differential phase shifter is configured to divide power from the first input between the first and second network outputs;
a second differential phase shifter comprising a second input, third and fourth network outputs, and a second phase shift adjuster which can be moved to adjust the phase difference between the third and fourth network outputs, wherein the second input is connected to the second main output and the second differential phase shifter is configured to divide power from the second input between the third and fourth network outputs;
and a control system configured to drive the first phase shift adjuster at a different rate to the second phase shift adjuster,
wherein the network has only an even number of network outputs.

In common with the first exemplary embodiment, this arrangement provides a reduced number of differential phase shifters, compared with the arrangement of FIG. 1. It also provides an alternative power division arrangement compared with FIG. 2. The even number of outputs is advantageous for use in an antenna with an even number of radiating elements.

The ratio between the first and second phase shift adjusters may fall outside the 1:3 ratio described above in connection with the first exemplary embodiment. When implemented in an antenna, this permits variation from equal spacing between adjacent radiating elements.

### BRIEF DESCRIPTION OF THE DRAWINGS

The invention will now be described by way of example with reference to the accompanying drawings, in which:

FIG. 1 is a schematic drawing of a prior art phase shifting network;

FIG. 2 is a schematic drawing of a second prior art phase shifting network;

FIG. 3 is a schematic drawing of an antenna incorporating a generic two-pair phase shifting network according to the invention;

FIG. 4 is a schematic drawing of a first embodiment of the generic network of FIG. 3;

FIG. 5 is a front view of the network of FIG. 4;

FIG. 6 is a rear view of the network of FIG. 4;

FIG. 7 is a schematic drawing of a second embodiment of the generic network of FIG. 3;

FIG. 8 is a schematic drawing of a third embodiment of the generic network of FIG. 3;

FIG. 9 is a schematic drawing of an antenna incorporating a generic three-pair phase shifting network according to the invention;

FIG. 10 is a schematic drawing of an antenna incorporating a first generic four-pair phase shifting network; and

FIG. 11 is a schematic drawing of an antenna incorporating a second generic four-pair phase shifting network.

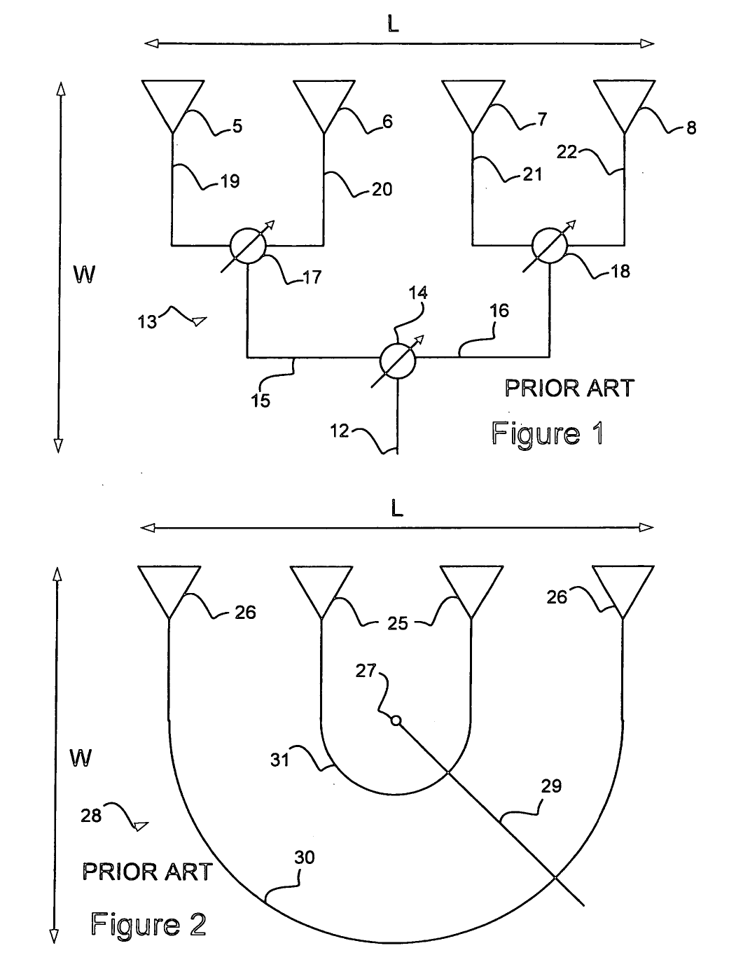

### DESCRIPTION OF THE INVENTION

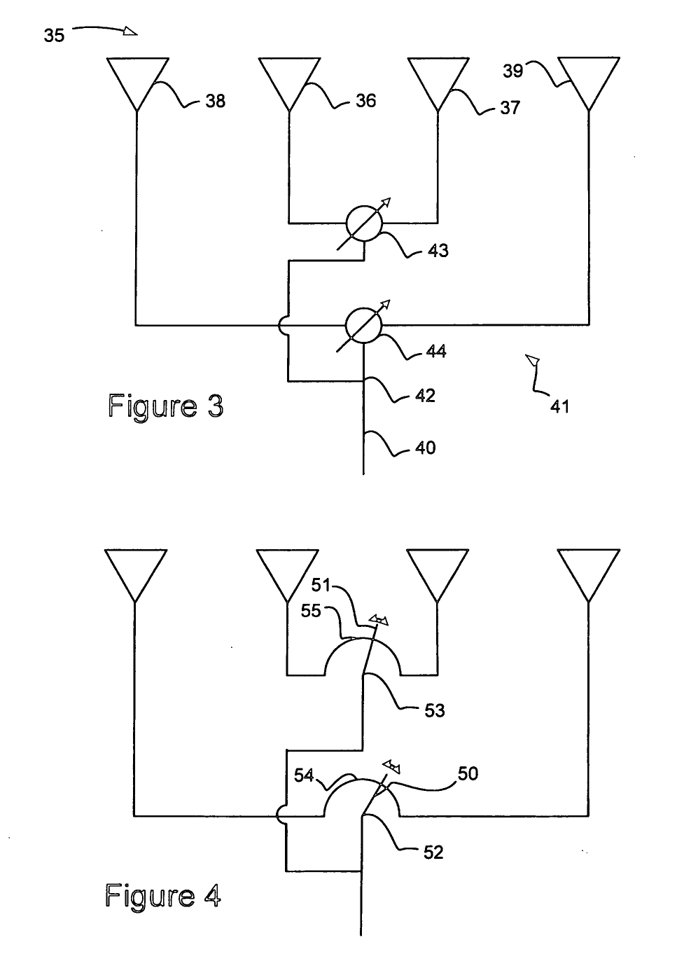

Referring to FIG. 3, an antenna 35 comprises four substantially equally spaced antenna elements 36, 37, 38, 39. The antenna is fed by a two-pair phase shifting network 41. The phase shifting network 41 includes a main input 40, main power divider 42 and first and second differential phase shifters 43 and 44. The first differential phase shifter 43 divides the signal and adjusts the relative phase between the antenna elements of the inner antenna element pair 36 and 37. The second differential phase shifter 44 divides the signal and adjusts the relative phase between the antenna elements of the outer antenna element pair 38 and 39. Each differential phase shifter adjusts the relative phase such that one of the antenna elements of the pair operates at a phase α, while the other antenna element operates at a phase −α.

Preferably the first and second differential phase shifters operate together such that the first antenna element 38 operates at a phase 3α; the second antenna element 36 operates at a phase α; the third antenna element 37 operates at a phase −α; and the fourth antenna element 39 operates at a phase −3α. Then the phase difference between any two adjacent antenna elements is 2α. Any adjustment of the second differential phase shifter 44 must result in approximately three times the adjustment of the first differential phase shifter 43. Various mechanisms for achieving this are described below.

While the differential phase shifters are arranged vertically in FIG. 3, they could advantageously be arranged side by side, parallel to the elements 36-39, to form a long thin profile which conforms with the profile of the antenna.

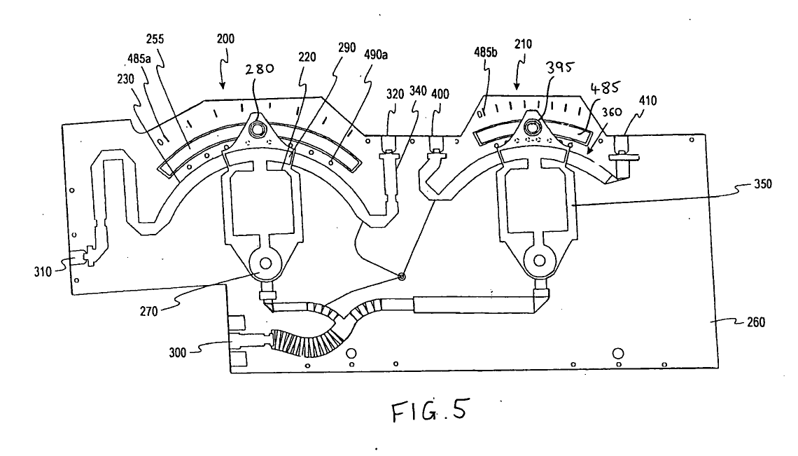

FIG. 4 shows an antenna with a two-pair phase shifting network as shown in FIG. 3, where each differential phase shifter comprises a wiper 50, 51 pivoted at an input point 52, 53. The wiper 50 couples to the curved transmission line 54, while the wiper 51 couples to the curved transmission line 55.

FIG. 5 shows a specific implementation of the two-pair phase shifting network of FIG. 4. The network is formed from a printed circuit board (PCB) 260. First and second differential phase shifters 200, 210 are fed by an input 300. The first differential phase shifter 200 includes a wiper 220, which is fixed to a pivot 270 and rotates around the pivot such that a portion of the wiper slides over a curved transmission line 230. The end of the wiper opposite the pivot 270 is mounted slidably in a slot 255. The second phase shifter 210 is similarly constructed.

The wiper is fabricated from a printed circuit board (PCB). The substrate of the PCB contacts the transmission line, separating the metallic side of the wiper from the transmission line. The metallic part of the wiper and the transmission line are then coupled capacitively. They are also separated by a fixed distance. This avoids problems with changing separation (and capacitance), which impairs impedance matching. At high frequencies the capacitive coupling is like a short circuit.

The metallic portion 290 of the wiper 220 above the curved transmission line is also curved and is shaped to increase the capacitance between portion 290 and the transmission line.

The lengths of transmission lines 240 and 340 are such that when the wiper 220 is aligned with the mark 485a, the phase difference between the first output 310 and the second output 320 is a first default phase difference. Similarly, when the wiper 350 is aligned with the mark 485b, the phase difference between the third output 400 and the fourth output 410 is a second default phase difference. Preferably, the second default phase difference is three times the first default phase difference, as described above.

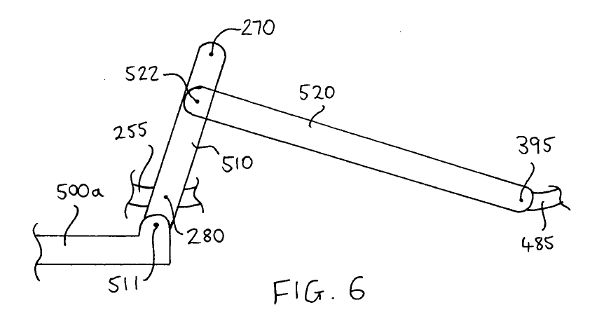

FIG. 6 is a schematic view of an actuating mechanism for driving the first differential phase shifter and the second differential phase shifter. The actuating mechanism acts at the rear of PCB 260. The actuating mechanism consists of a main drive arm 500a, pivotably connected to a first arm 510 at a pivot 511. The connection 280 connects the first arm 510 to the wiper 220, through the slot 255. The first arm 510 pivots around point 270. The first arm 510 is also pivotably connected to a second arm 520 at a pivot 522. The second arm 520 is connected to the second wiper 350 through the slot 485.

The pivot connecting the first arm to the second arm is situated approximately one third of the way along the first arm. Thus, when the first wiper moves through a distance, x, the second wiper moves through a distance x/3. This results in the required three to one ratio of phase adjustment as described above.

The drive arm 500a may be driven manually or by a remotely actuated motor.

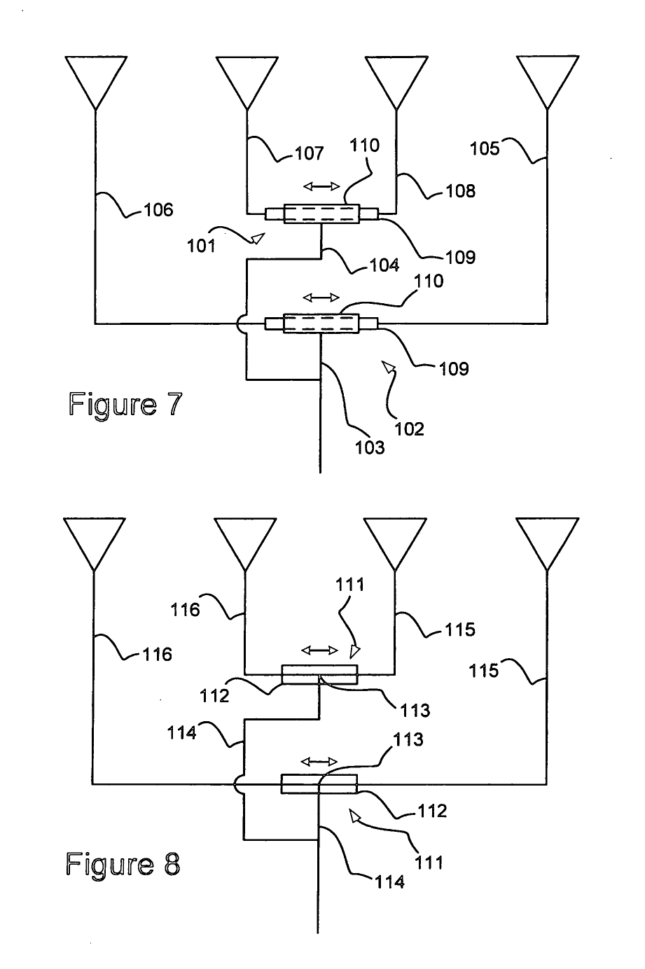

FIG. 7 shows a second embodiment of a two-pair phase shifting network. In this embodiment each of the first and second phase shifters 101, 102 comprises a conductive cylindrical sleeve 110 connected to an input 103, 104. The sleeve 110 can be moved linearly with respect to an inner core 109 connected to the transmission lines 105, 106, 107, 108. The first and second portions are arranged coaxially. The phase shifters 101,102 can be driven at the required 3:1 ratio by a rack and pinion mechanism as shown in FIG. 4 of WO 96/14670, or a threaded gear mechanism as shown in FIG. 6 of WO 96/14670.

FIG. 8 shows a third embodiment of a two-pair phase shifting network. In this embodiment each of the first and second phase shifters 111 comprises a dielectric slab 112 which can be moved linearly with respect to the feed network. Each dielectric slab overlaps a power divider junction 113. Each junction 113 divides the power from an input 114 between output 115, 116. When the dielectric slab 112 is moved relative to the junction 113, the slab overlaps one output line more or less than the other output line, so that the phase between the outputs 115, 116 is altered. An example of a dielectric differential phase shifter is described more fully in WO 03/019723. The two slabs 111,112 can be driven at the required 3:1 ratio by a rack and pinion mechanism as shown in FIG. 4 of WO 96/14670, or a threaded gear mechanism as shown in FIG. 6 of WO 96/14670.

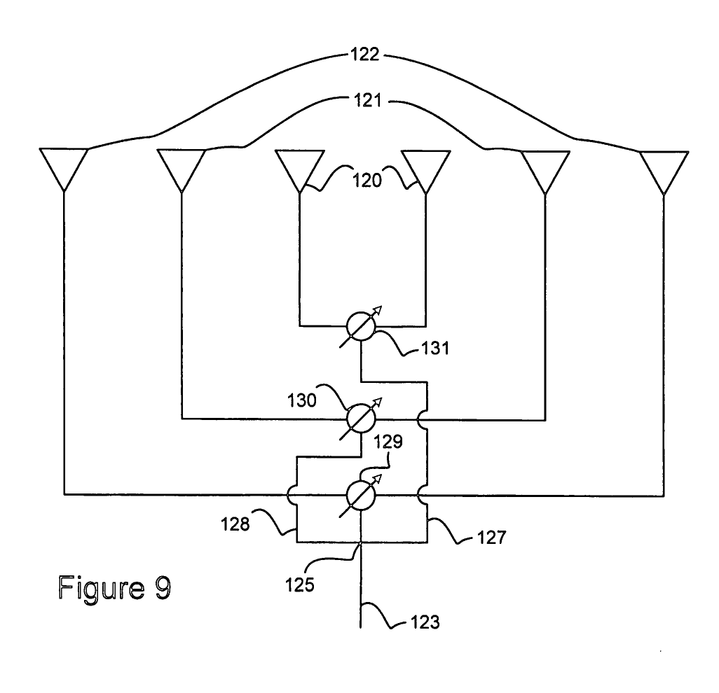

FIG. 9 shows an antenna with a three-pair phase shifting network. Three pairs of antenna elements 120, 121, 122 are fed by an input 123 via a three-pair phase shifting network 124. The three-pair phase shifting network 124 includes a main power divider 125, which receives the input signal from the input 123 and divides the signal between the three outputs 126, 127, 128. Each of the three outputs 126,127,128 feeds one of the three differential phase shifters 129, 130, 131. Each of the differential phase shifters feeds, and adjusts the phase between, elements of one of the antenna element pairs 120, 121, 122. The differential phase shifters are driven together, in a manner similar to that described above. Preferably, the relative differences in phase between adjacent antenna elements are approximately equal, thus requiring an adjustment ratio of approximately 1:3:5 between the phase shifters.

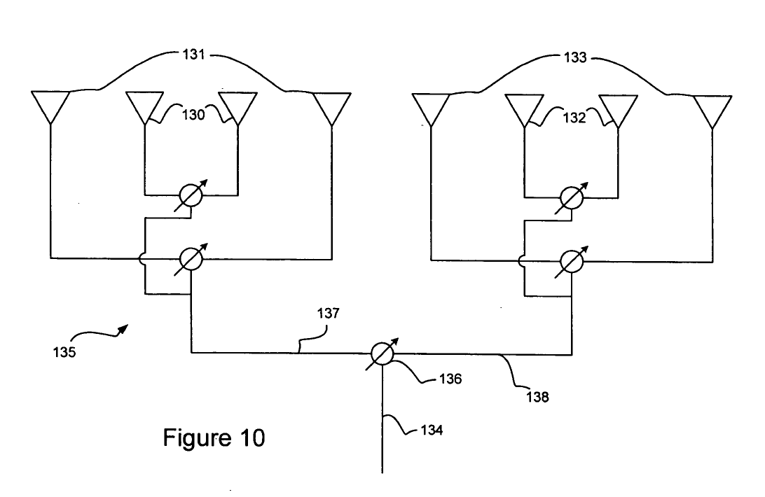

FIG. 10 shows an antenna incorporating a four-pair phase shifting network. Four pairs of antenna elements 130, 131, 132, 133 are fed by an input 134 via the phase shifting network 135. A principal differential phase shifter 136 receives the input signal from input 134 and divides it between outputs 137 and 138, each of which feeds a two-pair phase shifting network, of the type shown in FIG. 3. The network of FIG. 10 can be extended to feed 2n pairs of antenna elements, where n is a positive integer greater than two.

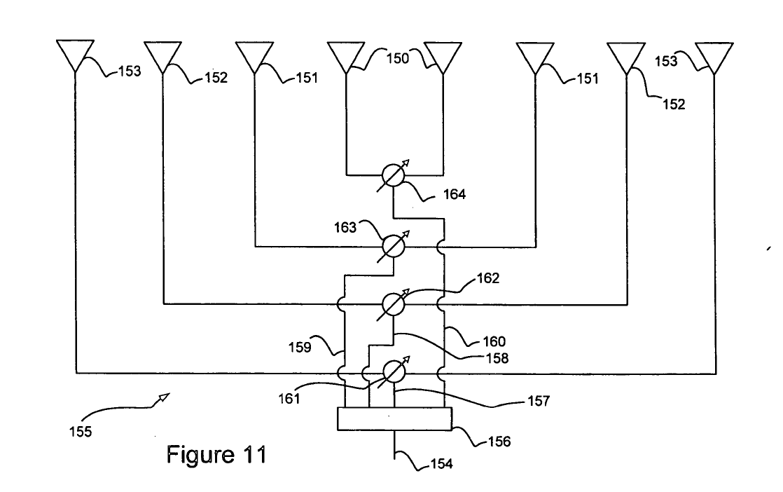

FIG. 11 shows an antenna with an alternative four-pair phase shifting network 155. Four pairs of antenna elements 150, 151, 152, 153 are fed by an input 154 via the phase shifting network 155. The phase shifting network 155 comprises a four way power divider 156, which receives the input signal from input 154 and divides it between outputs 157, 158, 159, 160. Each of these outputs feeds one of the differential phase shifters 161, 162, 163, 164. Each of the differential phase shifters feeds, and adjusts the phase between, antenna elements of one of the antenna element pairs 150, 151, 152, 153. The differential phase shifters are driven together at a ratio of approximately 1:3:5:7 to maintain the desired phase relationship between adjacent antenna elements. The phase shifting network of FIG. 11 can be extended to feed n pairs of antenna elements, where n is a positive integer greater than four.

Note that the serial coupling between phase shifters, as in the arrangement of FIG. 10, is preferred over the parallel arrangement of FIG. 11, since the degree of phase shift required from each phase shifter is smaller.

The networks described above are each designed with ratios between the phase shifters of approximately 1:3, 1:3:5, 1:3:5:7 etc (with a tolerance of the order of +/−5%). However in alternative embodiments it may be desirable to vary the ratios to optimize pattern features such as side lobe performance etc.

The phase shifting networks are described above in transmit mode: that is, receiving power from an input and feeding it to the antenna elements. However, the phase shifting networks can also operate in receive mode: that is, receiving power from the antenna elements and feeding it to the input.

In practice, the antennas shown are typically employed in a mobile wireless communication network base station, and operate both in transmit and receive mode.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A phase shifting network including:
a main power divider having a main input, first and second main outputs, and means for dividing power received at the main input between the first and second main outputs;
a first differential phase shifter comprising a first input, first and second outputs, and a first phase shift adjuster which can be moved to adjust the phase difference between the first and second outputs, wherein the first input is connected to the first main output and the first differential phase shifter is configured to divide power from the first input between the first and second outputs;
a second differential phase shifter comprising a second input, third and fourth outputs, and a second phase shift adjuster which can be moved to adjust the phase difference between the third and fourth outputs, wherein the second input is connected to the second main output and the second differential phase shifter is configured to divide power from the second input between the third and fourth outputs;
and a control system configured to drive the first phase shift adjuster and the second phase shift adjuster at a ratio of approximately 1:3.

2. A phase shifting network according to claim 1 wherein the ratio is 1:3+/−5%.

3. A phase shifting network as claimed in claim 1, wherein the first and second phase adjusters can be rotated to adjust the phase between the first and second, and third and fourth outputs.

4. A phase shifting network as claimed in claim 1, wherein the first and second phase adjusters can be moved linearly to adjust the phase between the first and second, and third and fourth outputs.

5. A phase shifting network as claimed in claim 1, wherein the main power divider further comprises a third main output, the means for dividing power dividing power received at the main input between the first, second and third main outputs; and
the phase shifting network includes a third differential phase shifter comprising a third input, fifth and sixth outputs, and a third phase shift adjuster which can be moved to adjust the phase difference between the fifth and sixth outputs, wherein the third input is connected to the third main output and the third differential phase shifter is configured to divide power from the third input between the fifth and sixth outputs,
wherein the control system is configured to drive the first, second and third phase shift adjusters at a ratio of approximately 1:3:5.

6. A combined phase shifting network comprising a principal differential phase shifter having a principal input, a plurality of principal outputs, and a principal phase shift adjuster which can be moved to adjust the phase differences between the principal outputs, wherein the principal differential phase shifter is configured to divide power from the principal input between the principal outputs; and
a plurality of phase shifting networks as claimed in claim 1;
wherein each of the plurality of principal outputs is connected to the main input of one of the plurality of phase shifting networks.

7. An antenna comprising four antenna elements arranged substantially linearly in an inner pair and an outer pair; and
a phase shifting network as claimed in claim 1, wherein the first and second outputs are connected to the antenna elements of the inner pair and the third and fourth outputs are connected to the antenna elements of the outer pair.

8. An antenna as claimed in claim 7, wherein the antenna elements are spaced apart substantially uniformly.

9. An antenna as claimed in claim 7, wherein the antenna elements are spaced apart along a length of the antenna, and the differential phase shifters are spaced apart along the length of the antenna.

10. An antenna has claimed in claim 9, wherein the differential phase shifters are arranged substantially linearly along a line parallel to the antenna elements.

11. A phase shifting network including:
a main power divider having a main input, first and second main outputs, and means for dividing power received at the main input between the first and second main outputs;
a first differential phase shifter comprising a first input, first and second network outputs, and a first phase shift adjuster which can be moved to adjust the phase difference between the first and second network outputs, wherein the first input is connected to the first main output and the first differential phase shifter is configured to divide power from the first input between the first and second network outputs;
a second differential phase shifter comprising a second input, third and fourth network outputs, and a second phase shift adjuster which can be moved to adjust the phase difference between the third and fourth network outputs, wherein the second input is connected to the second main output and the second differential phase shifter is configured to divide power from the second input between the third and fourth network outputs;
and a control system configured to drive the first phase shift adjuster at a different rate to the second phase shift adjuster,
wherein the network has only an even number of network outputs.

12. A phase shifting network as claimed in claim 11, wherein the first and second phase adjusters can be rotated to adjust the phase between the first and second, and third and fourth network outputs.

13. A phase shifting network as claimed in claim 11, wherein the first and second phase adjusters can be moved linearly to adjust the phase between the first and second, and third and fourth network outputs.

14. A phase shifting network as claimed in claim 11, wherein the main power divider further comprises a third main output, the means for dividing power dividing power received at the main input between the first, second and third main outputs; and
the phase shifting network includes a third differential phase shifter comprising a third input, fifth and sixth network outputs, and a third phase shift adjuster which can be moved to adjust the phase difference between the fifth and sixth network outputs, wherein the third input is connected to the third main output and the third differential phase shifter is configured to divide power from the third input between the fifth and sixth network outputs.

15. A combined phase shifting network comprising a principal differential phase shifter having a principal input, a plurality of principal outputs, and a principal phase shift adjuster which can be moved to adjust the phase differences between the principal outputs, wherein the principal differential phase shifter is configured to divide power from the principal input between the principal outputs; and
a plurality of phase shifting networks as claimed in claim 11;
wherein each of the plurality of principal outputs is connected to the main input of one of the plurality of phase shifting networks.

16. An antenna comprising four antenna elements arranged substantially linearly in an inner pair and an outer pair; and
a phase shifting network as claimed in claim 11, wherein the first and second network outputs are connected to the antenna elements of the inner pair and the third and fourth network outputs are connected to the antenna elements of the outer pair.

17. An antenna as claimed in claim 16, wherein the antenna elements are spaced apart substantially uniformly.

18. An antenna as claimed in claim 16, wherein the antenna elements are spaced apart along a length of the antenna, and the differential phase shifters are spaced apart along the length of the antenna.

19. An antenna has claimed in claim 18, wherein the differential phase shifters are arranged substantially linearly along a line parallel to the antenna elements.
